(19) United States
(12) Patent Application Publication
(10) Pub. No.: US 2015/0207174 A1
(43) Pub. Date: Jul. 23, 2015

(54) ELECTROLYTE AND RECHARGEABLE LITHIUM BATTERY INCLUDING SAME

(71) Applicant: Samsung SDI Co., Ltd., Yongin-si (KR)

(72) Inventors: Min-Ju LEE, Yongin-si (KR); Soo-Jin KIM, Yongin-si (KR); Myung-Heui WOO, Yongin-si (KR); Myung-Hwan JEONG, Yongin-si (KR); Woo-Cheol SHIN, Yongin-si (KR)

(21) Appl. No.: 14/569,489

(22) Filed: Dec. 12, 2014

(30) Foreign Application Priority Data
Jan. 20, 2014 (KR) 10-2014-0006879

(51) Int. Cl. H01M 10/0567; H01M 10/052

(52) U.S. Cl. CPC H01M 10/0567; H01M 10/052; H01M 2300/004; H01M 2220/30

(57) ABSTRACT

Disclosed are an electrolyte for a rechargeable lithium battery including a lithium salt, a non-aqueous organic solvent, and an additive, wherein the additive includes a compound represented by Chemical Formula 1, and rechargeable lithium battery including the same.

The structure and definition of the above Chemical Formula 1 are the same as in the specification.

### CROSS-REFERENCE TO RELATED APPLICATIONS

This application claims priority to and the benefit of Korean Patent Application No. 10-2014-0006879 filed in the Korean Intellectual Property Office on Jan. 20, 2014, the entire contents of which are incorporated herein by reference.

### BACKGROUND

1. Field

An electrolyte for a rechargeable lithium battery and a rechargeable lithium battery including the same are disclosed.

2. Description of the Related Art

Batteries transform chemical energy generated from an electrochemical redox reaction of a chemical material in the battery into electrical energy. Such batteries are divided into a primary battery, which should be disposed after the energy of the battery is all consumed, and a rechargeable battery, which may be recharged many times. The rechargeable battery may be charged/discharged many times based on the reversible transformation between chemical energy and electrical energy.

Recent developments in high-tech electronics have allowed electronic devices to become small and light in weight, which leads to an increase in portable electronic devices. As a power source for such portable electronic devices, the demands for batteries with high energy density are increasing and researches on lithium rechargeable battery are briskly under progress.

Rechargeable lithium batteries are manufactured by injecting an electrolyte into an electrode assembly, which includes a positive electrode including a positive active material capable of intercalating/deintercalating lithium and a negative electrode including a negative active material capable of intercalating/deintercalating lithium.

An electrolyte includes an organic solvent in which a lithium salt is dissolved and critically determines stability and performance of a rechargeable lithium battery. Particularly, research on an electrolyte for improving a cycle-life and stability of a rechargeable lithium battery has been actively made.

### SUMMARY

One embodiment provides an electrolyte for a rechargeable lithium battery having low initial resistance and excellent output characteristics and cycle-life characteristics.

Another embodiment provides a rechargeable lithium battery including the electrolyte.

In one embodiment, an electrolyte for a rechargeable lithium battery including a lithium salt, a non-aqueous organic solvent, and an additive, wherein the additive includes a compound represented by the following Chemical Formula 1.

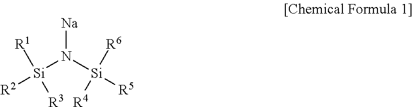

In the above Chemical Formula 1, R¹ to R⁶ are independently hydrogen, deuterium, a substituted or unsubstituted C1 to C8 alkyl group, a substituted or unsubstituted C2 to C12 alkenyl group, or a substituted or unsubstituted C2 to C12 alkynyl group.

The R¹ to R⁶ may be independently a substituted or unsubstituted C1 to C8 alkyl group.

The compound represented by the above Chemical Formula 1 may be sodium bis(trimethylsilyl)amide.

The compound represented by the above Chemical Formula 1 may be included in an amount of about 0.1 parts by weight to about 5 parts by weight based on 100 parts by weight of the non-aqueous organic solvent.

The compound represented by the above Chemical Formula 1 may be included in an amount of about 1 part by weight to about 5 parts by weight based on 100 parts by weight of the non-aqueous organic solvent.

According to another embodiment, a rechargeable lithium battery including a positive electrode, a negative electrode and the electrolyte for a rechargeable lithium battery is provided.

The rechargeable lithium battery may further include a SEI (solid electrolyte interphase) protection film positioned on the surface of the negative electrode.

The electrolyte for a rechargeable lithium battery according to one embodiment and the rechargeable lithium battery including the same have low initial resistance and excellent output and cycle-life characteristics.

### BRIEF DESCRIPTION OF THE DRAWINGS

FIG. 1 is an exploded perspective view showing a rechargeable lithium battery according to one embodiment.

FIG. 2 is a CV graph showing a cyclic voltammetry of rechargeable lithium battery cells according to Examples 1 and 2 and Comparative Example 1 at the 1 cycle.

FIG. 3 is a CV graph showing a cyclic voltammetry of the rechargeable lithium battery cell of Example 1 depending on a cycle number.

FIG. 4 is a CV graph showing a cyclic voltammetry of the rechargeable lithium battery cell of Example 2 depending on a cycle number.

FIG. 5 is a CV graph showing a cyclic voltammetry of the rechargeable lithium battery cell of Comparative Example 1 depending on a cycle number.

FIG. 6 is a graph showing cycle-life characteristics of the rechargeable lithium battery cells according to Example 1 and Comparative Example 1 depending on a cycle.

### DETAILED DESCRIPTION OF THE PREFERRED EMBODIMENT

Hereinafter, embodiments are illustrated in detail. However, these embodiments are examples, and this disclosure is not limited thereto.

As used herein, when a definition is not otherwise provided, the term “substituted” refers to one substituted with a C1 to C30 alkyl group; a C2 to C30 alkenyl group, a C2 to C30 alkynyl group, a C1 to C10 alkylsilyl group; a C3 to C30 cycloalkyl group; a C6 to C30 aryl group; a C1 to C30 heteroaryl group; a C1 to C10 alkoxy group; a silane group; an alkylsilane group; an alkoxysilane group; an amine group; an alkylamine group; an arylamine group; or a halogen, instead of at least one hydrogen of a compound.

As used herein, when a definition is not otherwise provided, the term “alkyl group” refers to a “saturated alkyl group” without an alkenyl group or an alkynyl group, or an “unsaturated alkyl group” including at least one of an alkenyl group or an alkynyl group. The term “alkenyl group” refers to a substituent including at least one carbon-carbon double bond, and the term “alkynyl group” refers to a substituent including at least one carbon-carbon triple bond. The alkyl group may be a branched, linear, or cyclic alkyl group.

An electrolyte for a rechargeable lithium battery according to one embodiment includes a lithium salt, a non-aqueous organic solvent, and an additive.

### Additive

The additive includes a compound represented by the following Chemical Formula 1.

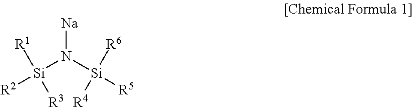

In the above Chemical Formula 1, R¹ to R⁶ are independently hydrogen, deuterium, a substituted or unsubstituted C1 to C8 alkyl group, a substituted or unsubstituted C2 to C12 alkenyl group, or a substituted or unsubstituted C2 to C12 alkynyl group. The compound represented by the above Chemical Formula 1 as the additive was added to an electrolyte for a rechargeable lithium battery and thus, may decrease initial resistance and improve output and cycle-life characteristics.

In other words, when the compound represented by the above Chemical Formula 1 may be decomposed into sodium ions (Na⁺) and amide-based anions ((SiR₃)₂N⁻) in the electrolyte, the sodium ions have a higher intercalation/deintercalation voltage than lithium ions (Li⁺) and thus, are earlier charged than the lithium ions during the charge but not deintercalated during the discharge, and accordingly, the lithium ions (Li⁺) may be relatively easily intercalated into a negative electrode and decrease initial resistance.

Accordingly, output characteristics of a rechargeable lithium battery according to one embodiment may be improved.

In addition, the amide-based anions form a SEI protection layer on the surface of the negative electrode and may improve stability thereof.

Accordingly, cycle-life and output characteristics of a rechargeable lithium battery according to one embodiment may be improved.

In the compound represented by the above Chemical Formula 1, the R¹ to R⁶ may be independently a substituted or unsubstituted C1 to C8 alkyl group.

For example, the compound represented by the above Chemical Formula 1 may be sodium bis(trimethylsilyl)amide.

The compound represented by the above Chemical Formula 1 may be included in an amount of about 0.1 parts by weight to about 5 parts by weight, about 0.5 parts by weight to about 5 parts by weight, or about 1 part by weight to about 5 parts by weight based on 100 parts by weight of the non-aqueous organic solvent. When the compound represented by the above Chemical Formula 1 is included within the amount range, initial resistance of a rechargeable lithium battery may not only be decreased but cycle-life characteristics thereof are also improved, while its excellent property balance is maintained.

### Non-Aqueous Organic Solvent

The non-aqueous organic solvent may include a carbonate-based, ester-based, ether-based, ketone-based, alcohol-based, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may be methyl acetate, ethyl acetate, n-propyl acetate, 1,1-dimethylethyl acetate, methyl propionate, ethyl propionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. The alcohol-based solvent may include ethanol, isopropyl alcohol, and the like, and the aprotic solvent may include nitriles such as R—CN (R is a hydrocarbon group having a C2 to C20 linear, branched, or cyclic structure, and may include a double bond, an aromatic ring, or an ether bond) and the like, amides such as dimethylformamide and the like, dioxolanes such as 1,3-dioxolane and the like, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent is prepared by mixing a cyclic carbonate and a linear carbonate. The cyclic carbonate and the linear carbonate are mixed together in the volume ratio of about 1:1 to about 1:9. Within this range, performance of electrolyte may be improved.

The non-aqueous organic electrolyte may be further prepared by mixing a carbonate-based solvent with an aromatic hydrocarbon-based solvent. The carbonate-based and the aromatic hydrocarbon-based solvents may be mixed together in a volume ratio of from about 1:1 to about 30:1.

The aromatic hydrocarbon-based organic solvent may be an aromatic hydrocarbon-based compound represented by the following Chemical Formula A.

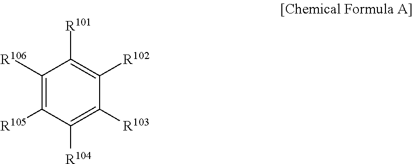

In the above Chemical Formula A, R¹⁰¹ to R¹⁰⁶ are independently hydrogen, a halogen, a C1 to C10 alkyl group, a C1 to C10 haloalkyl group, or a combination thereof

The aromatic hydrocarbon based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof

In order to improve battery cycle-life, the non-aqueous electrolyte may further include vinylene carbonate or an ethylene carbonate-based compound of the following Chemical Formula B.

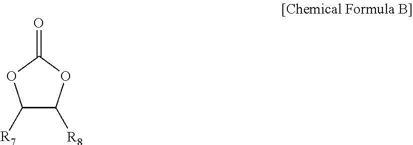

In the above Chemical Formula B, R₇ and R₈ are independently hydrogen, a halogen, a cyano group (CN), a nitro group (NO₂), or a C1 to C5 fluoroalkyl group, wherein at least one of the R₇ and R₈ is a halogen, a cyano group (CN), a nitro group (NO₂), or a C1 to C5 fluoroalkyl group.

Examples of the ethylene carbonate-based compound are difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used to improve cycle life may be adjusted within an appropriate range.

### Lithium Salt

The lithium salt is dissolved in an organic solvent, supplies lithium ions in a battery, operates a basic operation of the rechargeable lithium battery, and improves lithium ion transportation between positive and negative electrodes therein. Examples of the lithium salt may be LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, LiCl, LiI, LiB(C₂O₄)₂ (lithium bis(oxalato) borate; LiBOB) or a combination thereof, which is used as a supporting electrolytic salt. The lithium salt may be used in a concentration of from about 0.1 M to about 2.0 M. When the lithium salt is included at the above concentration range, an electrolyte may have excellent performance and lithium ion mobility due to optimal electrolyte conductivity and viscosity.

According to another embodiment, a rechargeable lithium battery including a positive electrode, a negative electrode and the electrolyte is provided.

The amide-based anions of the compound represented by the above Chemical Formula 1 may form a SEI protection layer on the surface of the negative electrode. Specific examples of the amide-based anions may be bis(trimethylsilyl)amide.

A rechargeable lithium battery can be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it can be bulk type and thin film type depending on size. Structures and manufacturing methods for lithium ion batteries pertaining to this disclosure are well-known in the art.

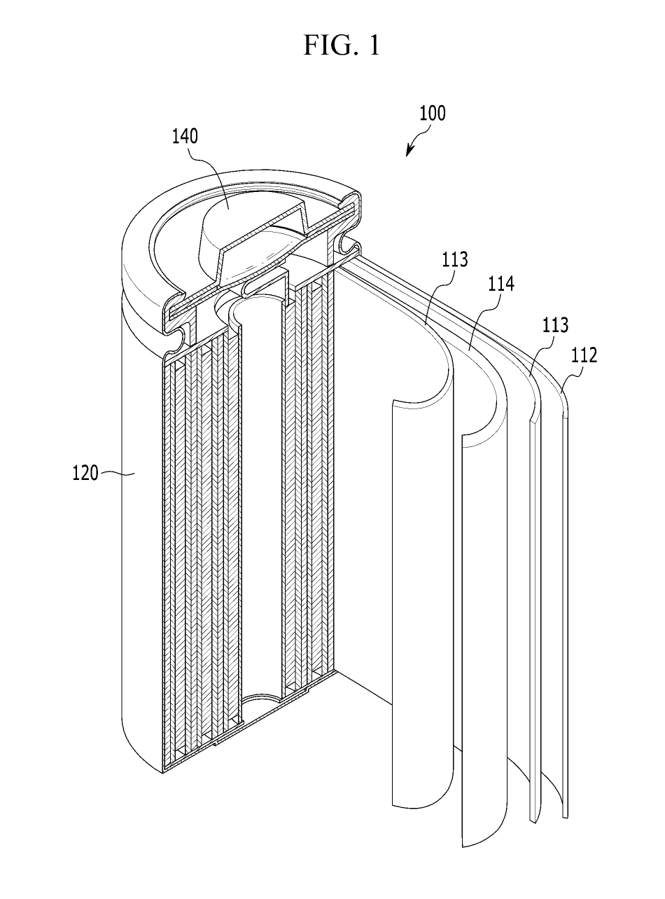

FIG. 1 is an exploded perspective view of a rechargeable lithium battery according to one embodiment. Referring to FIG. 1, the lithium secondary battery 100 is a cylindrical battery including a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The negative electrode 112, separator 113, and positive electrode 114 are sequentially stacked, spirally wound, and placed in a battery case 120 to fabricate such a lithium secondary battery 100.

### Positive Electrode

The positive electrode 114 includes a current collector and a positive active material layer formed on the current collector.

The current collector may use Al, but is not limited thereto.

The positive active material layer includes a positive active material, a binder, and optionally a conductive material.

The positive active material may include lithiated intercalation compounds that reversibly intercalate and deintercalate lithium ions. Specifically, the positive active material may be lithium composite oxide including at least one metal selected from cobalt, manganese, nickel, or a combination thereof. For more specific examples, the compounds represented by the following chemical formulae may be used.

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiₐE_{2-b}R_{b}O_{4-c}D_{c} (0.90≦a≦1.8, 0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α<2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α<2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu or a combination thereof.

The compounds may have a coating layer on the surface or may be mixed with compounds having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compounds for a coating layer may be amorphous or crystalline. The coating element for a coating layer may include Mg, Al, Co, K, Na, Ca, Si, Ti, V, Sn, Ge, Ga, B, As, Zr, or a mixture thereof. The coating layer may be formed in a method having no negative influence on properties of a positive active material by including these elements in the compound. For example, the method may include any coating method such as spraying, dipping, and the like.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves conductivity of an electrode. Any electrically conductive material may be used as a conductive material, unless it causes a chemical change. Examples thereof may be one or more of natural graphite, artificial graphite, carbon black, acetylene black, ketjen black, a carbon fiber, a metal powder, a metal fiber, and the like of copper, nickel, aluminum, silver, and the like, and a conductive polymer such as a polyphenylene derivative.

### Negative Electrode

The negative electrode 112 includes a current collector and a negative active material layer formed on the current collector. The negative active material layer includes a negative active material.

The negative active material includes a material that reversibly intercalates/deintercalates lithium ions, a lithium metal, a lithium metal alloy, a material being capable of doping and dedoping lithium, or a transition metal oxide.

The material that can reversibly intercalate/deintercalate lithium ions includes a carbon material. The carbon material may be any carbon-based negative active material generally used in a lithium ion rechargeable battery. Examples of the carbon material include crystalline carbon, amorphous carbon, and mixtures thereof. The crystalline carbon may be non-shaped, or sheet, flake, spherical, or fiber-shaped natural graphite or artificial graphite. The amorphous carbon may be a soft carbon, a hard carbon, a mesophase pitch carbonized product, fired coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material being capable of doping and dedoping lithium may include Si, SiOₓ (0<x<2), a Si—C composite, a Si-Q alloy (wherein Q is an alkali metal, an alkaline-earth metal, Group 13 to 16 elements, a transition metal, a rare earth element or a combination thereof, and not Si), Sn, SnO₂, a Sn—C composite, a Sn—R (wherein R is an alkali metal, an alkaline-earth metal, Group 13 to 16 elements, a transition metal, a rare earth element, or a combination thereof, and not Sn), and the like. The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof

The transition metal oxide may be vanadium oxide, lithium vanadium oxide, and the like.

The negative active material layer also includes a binder and optionally a conductive material.

The binder improves binding properties of the positive active material particles to one another and also, with a current collector. Examples of the binder include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material unless it causes a chemical change. Examples of the conductive material include carbon-based materials such as natural graphite, artificial graphite, carbon black, acetylene black, ketjen black, a carbon fiber, and the like; a metal-based material such as a metal powder or a metal fiber of copper, nickel, aluminum, silver, and the like; a conductive polymer such as a polyphenylene derivative, and the like; or mixtures thereof

The current collector may be selected from the group consisting of a copper film, a nickel film, a stainless steel film, a titanium film, a nickel foam, a copper foam, a polymer substrate coated with a conductive metal, and a combination thereof

The negative electrode 112 and the positive electrode 114 may be manufactured by mixing the active material, a conductive material, and a binder into an active material composition and coating the composition on a current collector. The electrode manufacturing method is well known, and thus is not described in detail in the present specification. Examples of the solvent include N-methylpyrrolidone and the like, but is not limited thereto.

### Separator

The rechargeable lithium battery according to one embodiment may include a separator 113. The separator may include any materials commonly used in the conventional lithium battery as long as separating a negative electrode from a positive electrode and providing a transporting passage of lithium ions. It may have a low resistance to ion transport and an excellent impregnation for electrolyte. For example, it may be selected from a glass fiber, polyester, TEFLON (tetrafluoroethylene), polyethylene, polypropylene, polytetrafluoroethylene (PTFE), or a combination thereof. It may have a form of a non-woven fabric or a woven fabric. For example, for the lithium ion battery, polyolefin-based polymer separator such as polyethylene, polypropylene or the like is mainly used. In order to ensure the heat resistance or mechanical strength, a coated separator including a ceramic component or a polymer material may be used. Selectively, it may have a mono-layered or multi-layered structure.

Hereinafter, examples of the present embodiments and comparative examples are described. These examples, however, are not in any sense to be interpreted as limiting the scope of the embodiments.

### Example 1

### Preparation of Electrolyte

An electrolyte for a rechargeable lithium battery was manufactured by mixing ethylene carbonate (EC), ethylmethyl carbonate (EMC), and dimethyl carbonate (DMC) (EC/EMC/DMC=2/4/4 of a volume ratio) to prepare a non-aqueous organic solvent, adding a LiPF₆ lithium salt thereto, and adding an additive represented by the following Chemical Formula 1a to the mixture. Herein, the lithium salt was included in a concentration of 1.15 M, and the additive was added in an amount of 1 part by weight based on 100 parts by weight of the non-aqueous organic solvent.

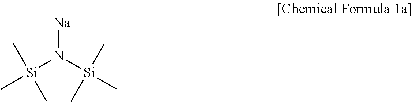

### Manufacture of Rechargeable Lithium Battery Cell

A positive electrode was manufactured by mixing 97.4 wt % of LiCoO₂ as a positive active material, 1.3 wt % of polyvinylidene fluoride as a binder, and 1.3 wt % of Super-P as a conductive material and dispersing the mixture into N-methylpyrrolidone to prepare a positive active material layer composition, coating the positive active material layer composition on an aluminum foil, and then, drying and compressing it.

A negative electrode was manufactured by mixing 98 wt % of graphite as a negative active material, 1 wt % of polyvinylidene fluoride as a binder, and 1 wt % of Super-P as a conductive material and dispersing the mixture into N-methylpyrrolidone to prepare a negative active material layer composition, coating the negative active material layer composition on a copper foil, and then, drying and compressing it.

The positive and negative electrodes along with a polypropylene separator were inserted into a battery case, and the electrolyte was injected thereinto, manufacturing a rechargeable lithium battery cell.

### Example 2

A rechargeable lithium battery cell was manufactured according to the same method as Example 1 except for using 3 parts by weight of the additive based on 100 parts by weight of the non-aqueous organic solvent.

### Comparative Example 1

A rechargeable lithium battery cell was manufactured according to the same method as Example 1 except for using no compound represented by Chemical Formula 1-a as an electrolyte additive.

### Comparative Example 2

A rechargeable lithium battery cell was manufactured according to the same method as Example 1 except for using 1 part by weight of lithiumbis(trimethylsilyl)amide (Li(Si(CH₃)₃)₂) based on 100 parts by weight of the non-aqueous organic solvent instead of the compound represented by the above Chemical Formula 1-a as an electrolyte additive.

### Evaluation Example 1

### Circulating Current Characteristics of Rechargeable Lithium Battery Cell

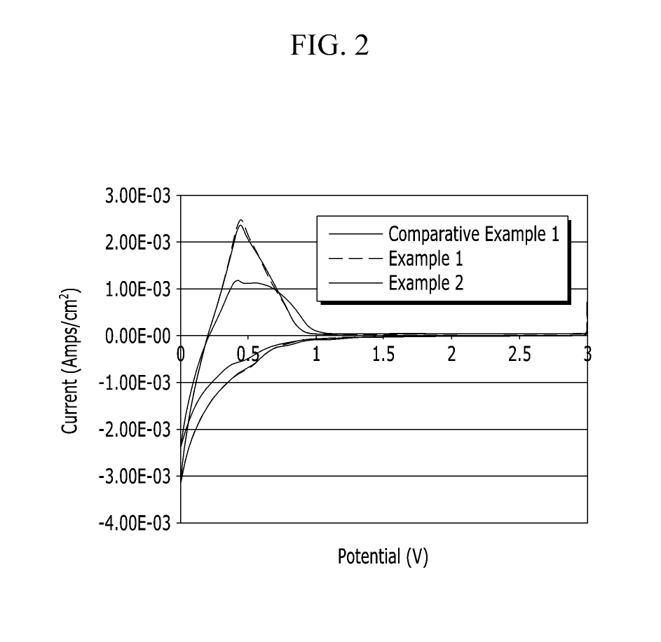

FIG. 2 is a graph showing a cyclic voltammetry of the rechargeable lithium battery cells according to Examples 1 and 2 and Comparative Example 1 at the first cycle.

Referring to FIG. 2, the rechargeable lithium battery cell using the electrolyte including the additive showed an increased cyclic voltammetry compared with the rechargeable lithium battery cell using an electrolyte including no additive.

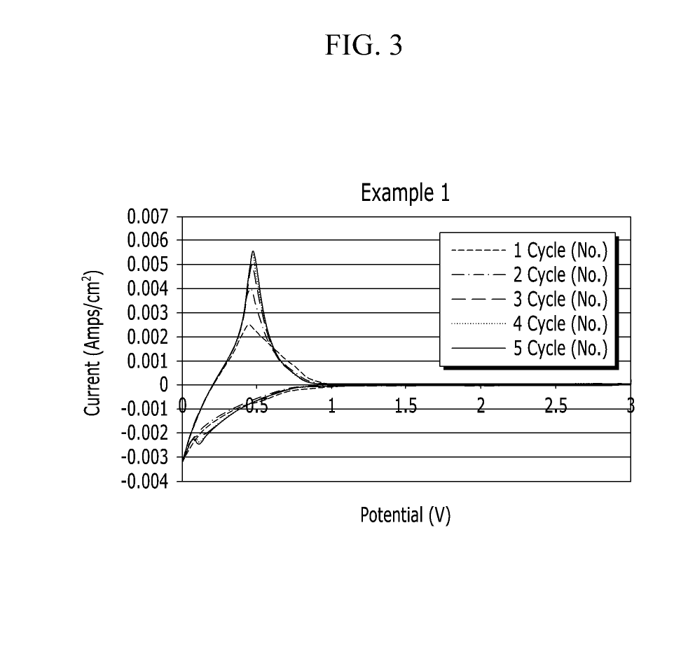

Cyclic voltammetry of the rechargeable lithium battery cells according to Examples 1 and 2 and Comparative Example 1 was changed from the first cycle to the fifth cycle and measured, and the results are provided in FIGS. 3 to 5.

FIG. 3 is a CV graph showing a cyclic voltammetry of the rechargeable lithium battery cell according to Example 1 depending on a cycle number.

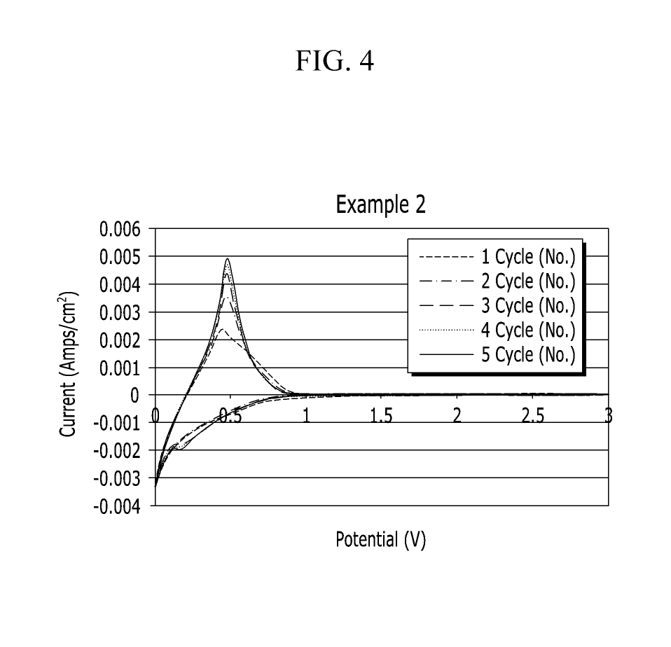

FIG. 4 is a CV graph showing a cyclic voltammetry of the rechargeable lithium battery cell according to Example 2 depending on a cycle number.

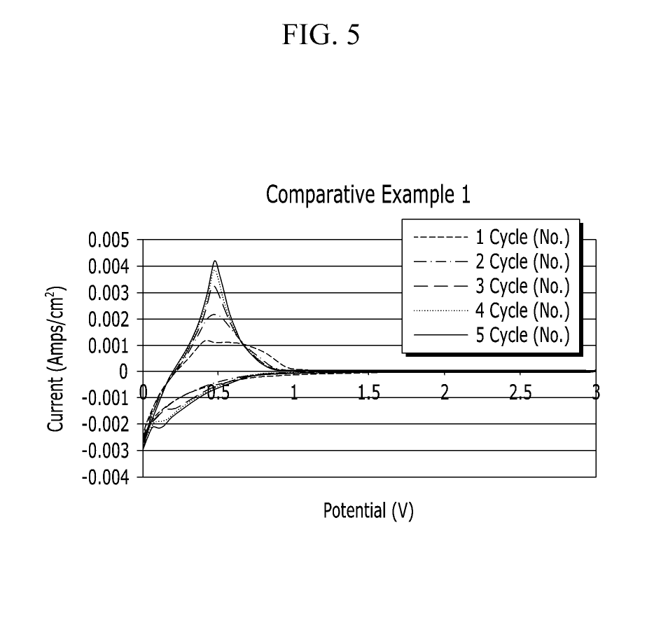

FIG. 5 is a CV graph showing a cyclic voltammetry of the rechargeable lithium battery cell according Comparative Example 1 depending on a cycle number.

Referring to FIGS. 3 to 5, the cyclic voltammetry increased, as the cycle number was increased.

In other words, the rechargeable lithium battery cell using an electrolyte including an additive according to one embodiment showed improved battery characteristics such as output characteristics, cycle-life characteristics, and the like, since the electrolyte was decomposed and formed a layer on the surface of a negative electrode due to stable intercalation/deintercation of lithium.

### Evaluation Example 2

### Cycle-Life Characteristics of Rechargeable Lithium Battery Cell

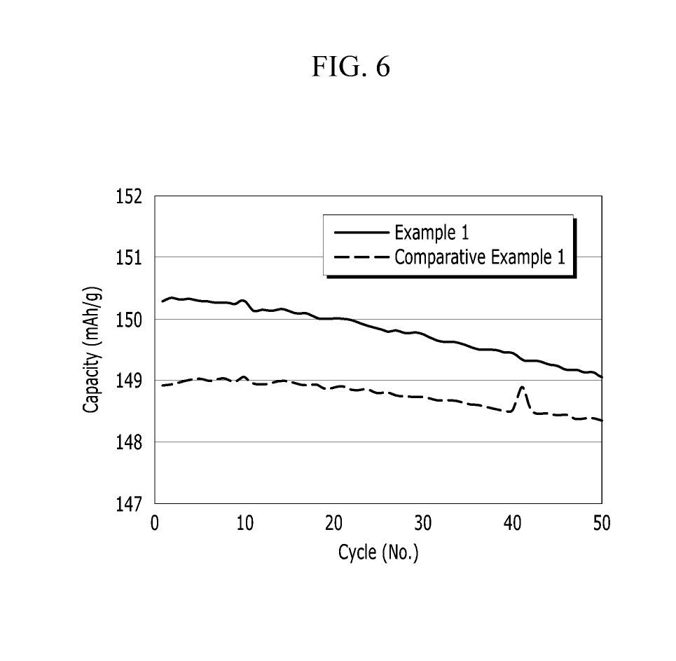

Specific discharge capacity change of the rechargeable lithium battery cells according to Example 1 and Comparative Example 1 depending on a cycle was measured, and the results are provided in FIG. 6. (1C charge and 1C: discharge at a temperature of 25° C.)

FIG. 6 is a graph showing cycle-life characteristics of the rechargeable lithium battery cells according to Example 1 and Comparative Example 1 depending on a cycle.

Referring to FIG. 6, the rechargeable lithium battery cell of Example 1 showed excellent cycle-life characteristics compared with the rechargeable lithium battery cell according to Comparative Example 1.

### Evaluation Example 3

### Initial Resistance of Rechargeable Lithium Battery Cell

Initial resistance of the rechargeable lithium battery cells according to Example 1 and Comparative Example 1 was measured, and the results are provided in the following Table 1.

The initial resistance was measured in a DC-IR method.

Specifically, the initial resistance was measured for 10 seconds by applying a DC current of 1 A in a S0050 state to the battery cells.

The initial resistance was twice measured under the same condition and then, averaged and provided in the following Table 1.

TABLE 1

| | Initial resistance |
|---|---|
| | for 0-10 sec (mΩ) |
| Comparative Example 1 | 404.901 |
| Example 1 | 293.151 |

Referring to Table 1, the rechargeable lithium battery cell according to Example 1 showed remarkably reduced initial resistance compared with the rechargeable lithium battery cell according to Comparative Example 1.

Accordingly, a rechargeable lithium battery one embodiment will show excellent initial output.

While these embodiments have been described in connection with what is presently considered to be practical example embodiments, it is to be understood that the present embodiments are not limited to the disclosed embodiments, but, on the contrary, are intended to cover various modifications and equivalent arrangements included within the spirit and scope of the appended claims.

What is claimed is:

1. An electrolyte for a rechargeable lithium battery, comprising
a lithium salt, a non-aqueous organic solvent, and an additive,
wherein the additive comprises a compound represented by the following Chemical Formula 1: 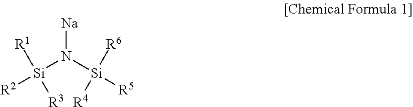
wherein,
R¹ to R⁶ are independently hydrogen, deuterium, a substituted or unsubstituted C₁ to C₈ alkyl group, a substituted or unsubstituted C₂ to C₁₂ alkenyl group, or a substituted or unsubstituted C₂ to C₁₂ alkynyl group.

2. The electrolyte of claim 1, wherein R¹ to R⁶ are independently a substituted or unsubstituted C₁ to C₈ alkyl group.

3. The electrolyte of claim 1, wherein R¹ to R⁶ are independently an unsubstituted C₁ to C₄ alkyl group.

4. The electrolyte of claim 1, wherein the compound represented by Chemical Formula 1 is sodium bis(trimethylsilyl)amide.

5. The electrolyte of claim 1, wherein the compound represented by Chemical Formula 1 is Chemical Formula 1a:

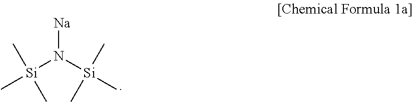

6. The electrolyte of claim 1, wherein the lithium salt is LiPF₆.

7. The electrolyte of claim 1, wherein the non-aqueous organic solvent comprises at least one of ethylene carbonate (EC), ethylmethyl carbonate (EMC), and dimethyl carbonate.

8. The electrolyte of claim 1, wherein the non-aqueous organic solvent comprises ethylene carbonate (EC), ethylmethyl carbonate (EMC), and dimethyl carbonate.

9. The electrolyte of claim 1, wherein the compound represented by Chemical Formula 1 is included in an amount of about 0.1 parts by weight to about 5 parts by weight based on 100 parts by weight of the non-aqueous organic solvent.

10. The electrolyte of claim 1, wherein the compound represented by Chemical Formula 1 is included in an amount of about 1 part by weight to about 5 parts by weight based on 100 parts by weight of the non-aqueous organic solvent.

11. A rechargeable lithium battery, comprising
a positive electrode,
a negative electrode and
an electrolyte comprising:
a lithium salt, a non-aqueous organic solvent, and an additive,
wherein the additive comprises a compound represented by the following Chemical Formula 1: 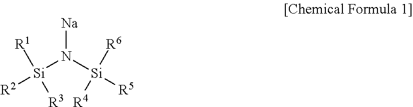
wherein,
R¹ to R⁶ are independently hydrogen, deuterium, a substituted or unsubstituted C₁ to C₈ alkyl group, a substituted or unsubstituted C₂ to C₁₂ alkenyl group, or a substituted or unsubstituted C₂ to C₁₂ alkynyl group.

12. The rechargeable lithium battery of claim 11, wherein R¹ to R⁶ are independently a substituted or unsubstituted C₁ to C₈ alkyl group.

13. The rechargeable lithium battery of claim 11, wherein R¹ to R⁶ are independently an unsubstituted C₁ to C₄ alkyl group.

14. The rechargeable lithium battery of claim 11, wherein the compound represented by Chemical Formula 1 is sodium bis(trimethylsilyl)amide.

15. The rechargeable lithium battery of claim 11, wherein the compound represented by Chemical Formula 1 is Chemical Formula 1a:

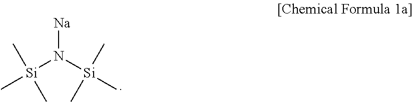

16. The rechargeable lithium battery of claim 11, wherein the lithium salt is LiPF₆.

17. The rechargeable lithium battery of claim 11, wherein the non-aqueous organic solvent comprises at least one of ethylene carbonate (EC), ethylmethyl carbonate (EMC), and dimethyl carbonate.

18. The rechargeable lithium battery of claim 11, wherein the compound represented by Chemical Formula 1 is included in an amount of about 0.1 parts by weight to about 5 parts by weight based on 100 parts by weight of the non-aqueous organic solvent.

19. The rechargeable lithium battery of claim 11, wherein the compound represented by Chemical Formula 1 is included in an amount of about 1 part by weight to about 5 parts by weight based on 100 parts by weight of the non-aqueous organic solvent.

20. The rechargeable lithium battery of claim 11, wherein the rechargeable lithium battery further comprises a SEI (solid electrolyte interphase) protection film positioned on the surface of the negative electrode.
